(19) United States
(12) Patent Application Publication
(10) Pub. No.: US 2024/0426368 A1
(43) Pub. Date: Dec. 26, 2024

(54) DRIVE DEVICE FOR A MOTOR VEHICLE WITH SIMILAR SUN GEARS

(71) Applicant: Schaeffler Technologies AG & Co. KG, Herzogenaurach (DE)

(72) Inventor: Franz VOELKEL, Nürnberg (DE)

(73) Assignee: Schaeffler Technologies AG & Co. KG, Herzogenaurach (DE)

(21) Appl. No.: 17/629,062

(22) PCT Filed: Jul. 15, 2020
(86) PCT No.: PCT/DE2020/100615

§ 371 Date: Jan. 21, 2022

(30) Foreign Application Priority Data
Jul. 24, 2019 (DE) 102019119950.6

(51) Int. Cl. F16H 3/66

(52) U.S. Cl. CPC F16H 3/666; F16H 2200/2007; F16H 2200/2097

(57) ABSTRACT

A drive device for a motor vehicle, includes an electrical drive machine connected to a transmission device by a drive shaft, wherein the transmission device has first and second planetary gear stages and a differential stage. The first planetary stage has a first planetary gear set with planetary gears arranged on a first planetary gear carrier and mesh with first sun and ring gears. The second planetary gear stage has a second planetary gear set with planetary gears arranged on a second planetary gear carrier and mesh with second and ring sun gears. The first and the second planetary gear sets are actively connected to a dual clutch device which contains first and second load-switchable clutches. The first and second sun gears are interconnected in a rotatable manner and the drive shaft is actively connected to both sun gears, and the first and second sun gears have the same half circuit diameter.

### CROSS-REFERENCE TO RELATED APPLICATIONS

This application is the U.S. National Phase of PCT Appln. No. PCT/DE2020/100615, filed Jul. 15, 2020, which claims priority from German Patent Application No. 10 2019 119 950.6, filed Jul. 24, 2019, the entire disclosures of which are incorporated by reference herein.

### TECHNICAL FIELD

The disclosure relates to a drive device for a motor vehicle, in particular for an electrically driven motor vehicle, having an electrical drive machine which is operatively connected to a transmission device by means of a drive shaft, wherein the transmission device has at least one first and one second planetary gear stage and a differential stage, wherein the first planetary stage comprises a first planetary gear set having a plurality of planetary gears, wherein the planetary gears of the first planetary gear set are rotatably arranged on a first planetary gear carrier and mesh with a first sun gear and with a first ring gear, wherein the second planetary gear stage comprises a second planetary gear set having a plurality of planetary gears, wherein the planetary gears of the second planetary gear set are rotatably arranged on a second planetary gear carrier and mesh with a second sun gear and with a second ring gear, wherein the first and the second planetary gear sets are operatively connected to a dual clutch device, having a first and a second load-switchable clutch, wherein the first sun gear and the second sun gear are interconnected in a rotatable manner and the drive shaft is operatively connected to both sun gears, in particular in a rotationally fixed manner.

### BACKGROUND

Drive devices for motor vehicles are already known from the prior art. For example, DE 10 2011 088 668 A1 shows a drive device with at least one electrical drive machine, with at least one first planetary drive with a clutch and with a differential. A rotor shaft of the drive machine is coupled in a rotationally fixed manner to a first connection shaft of the planetary drive formed from at least three connection shafts. A second connection shaft of the first planetary drive can be fixed in a rotationally fixed manner against a component of the drive device by means of a shift collar of the clutch. A third connection shaft of the first planetary drive is operatively connected to a sum shaft of the differential. The shift collar can be shifted into positive engagement either with the second connection shaft of the first planetary drive or in a torque-transmitting operative connection with the sum shaft of the differential.

DE 10 2013 210 320 A1 also discloses a planetary gearing for splitting the drive power applied to a power input to a first and a second power output. The planetary gearing thus comprises a first planetary gear stage that comprises a first sun gear, a first planetary gear set, a first planetary gear carrier and a first ring gear, and a second planetary gear stage that comprises a second sun gear, a second planetary gear set, a second planetary gear carrier and a second ring gear. The first ring gear functions as a power input and the first sun gear is coupled to the second sun gear in a rotationally fixed manner. The second planetary gear carrier is fixed in a fixed manner. The first planetary gear carrier represents the first power output and the second ring gear represents the second power output.

CN 109 099 131 A discloses two planetary gear sets, the ring gears of which can each be set fixed to the frame via a brake and one planetary gear carrier of one planetary gear set is permanently coupled to the ring gear of the other planetary gear set.

### SUMMARY

It is the object of the disclosure to further develop a drive device for a motor vehicle, wherein the focus is on the simplest possible transmission structure with many identical parts and a suitable gear ratio distribution or spread.

This object is achieved in a generic device having one or more of the features described herein.

The drive device according to the disclosure for a motor vehicle comprises an electrical drive machine which is operatively connected to a transmission device via a drive shaft.

The transmission device has at least one first and one second planetary gear stage and a differential stage, wherein the first planetary stage comprises a first planetary gear set having a plurality of planetary gears, wherein the planetary gears of the first planetary gear set are rotatably arranged on a first planetary gear carrier and mesh with a first sun gear and with a first ring gear, wherein the second planetary gear stage comprises a second planetary gear set having a plurality of planetary gears, wherein the planetary gears of the second planetary gear set are rotatably arranged on a second planetary gear carrier and mesh with a second sun gear and with a second ring gear, and wherein the first and the second planetary gear sets are operatively connected to a dual clutch device, having a first and a second load-switchable clutch.

The term “operatively connected” thus means that two transmission elements for torque transmission may be directly connected or that there are other transmission elements between two transmission elements for torque transmission, e.g., one or more shafts or gear wheels. Two meshing or intermeshing gear wheels are provided to transmit torque and speed from one gear wheel to the other gear wheel. A gear means, for example, a sun gear, a ring gear or a planet gear of a planetary gear set.

A dual clutch device means a device with two load-switchable clutches. Furthermore, the term “load-shiftable clutch” means a device that has at least one open and one closed state and can be shifted between the at least two states under load. In the open state, the clutch does not transmit any torque.

In a first embodiment, the first planetary gear carrier can be connected in a fixed manner to a housing via the first clutch and the first ring gear can be fixedly connected to the housing via the second clutch. In addition, it is expedient if the second planetary gear carrier is operatively connected to the differential stage.

In other words, the dual clutch device can be arranged in a fixed manner with the housing on the input side and can optionally connect the first planetary gear carrier or the first ring gear fixed to the housing. On the output side, the second planetary gear carrier is operatively connected to the differential stage, so that the torque is transmitted to the differential stage via the second planetary gear carrier.

Alternatively, in a second embodiment, the second planetary gear carrier can be operatively connected to the differential stage via the first clutch and the second ring gear can be operatively connected to the differential stage via the second clutch. The first ring gear can preferably be connected to the housing in a fixed manner.

In other words, the dual clutch device can be arranged on the output side and thereby optionally operatively connect the second planetary gear carrier or the second ring gear to the differential stage. The transmission device is supported in a fixed manner via the first ring gear in the housing.

Advantageous embodiments are explained below.

It is advantageous if the toothing of the first sun gear is designed identical to the toothing of the second sun gear, i.e., if the first sun gear has the same toothing as the toothing of the second sun gear. As a result, the two sun gears can be manufactured identically, which reduces manufacturing costs.

The drive shaft can thus preferably be designed in one piece with the first sun gear and the second sun gear as an integral component, so that the assembly of the transmission device can be facilitated.

In one embodiment, the first planetary gear carrier can be connected to the second ring gear in a rotationally fixed manner.

The first and second clutch of the dual clutch device can preferably be designed as a friction clutch. Furthermore, the two clutches can preferably be arranged coaxially to one another. In particular, the respective clutch can be actuated by a respective actuator in order to initiate opening or closing of the respective clutch. The actuator can be implemented hydraulically, electromechanically, electromagnetically or, for example, even pneumatically.

It is useful here if opening both clutches can implement a power cut-off at the same time. Closing the first clutch and opening the second clutch can implement a first gear ratio, whereas closing the second clutch and opening the first clutch can implement a second gear ratio. In order to ensure that the shifting process from one clutch to the other clutch is largely free of traction force loss, one clutch can open in a transitional period while the other closes. Via the slip in the clutches, designed as friction clutches, a torque-loss free switchover between two gear stages can take place, which can be perceived by the operator of the drive device as a switchover mode between two gear stages without loss of traction, which in turn increases the switching comfort for the operator of the drive device. The first gear ratio is preferably not the same as the second gear ratio. For example, the first gear ratio can be greater than the second gear ratio. Alternatively, the first gear ratio can be smaller than the second gear ratio.

According to a design according to the disclosure, the electrical machine can have a stator and a rotor, wherein the rotor is connected to the drive shaft in a rotationally fixed manner. The drive shaft can be designed as a rotor shaft or there is an axial offset between the drive shaft and the rotor shaft, wherein a torque transmission device (transmission) is arranged between the two shafts.

Furthermore, the differential stage can preferably be designed as a spur gear differential, wherein the differential stage is provided to distribute a drive power of the drive machine to a first and a second output shaft.

The drive machine can be arranged coaxially or axially parallel to the differential stage. In particular, the drive machine and/or the drive shaft can be arranged axially parallel to the two output shafts, wherein axially parallel means that there is an axial offset between the drive shaft and the output shafts. As a result, the axial installation space of the drive device can be reduced.

If the drive shaft is arranged coaxially to the two output shafts, the drive shaft can be designed as a hollow shaft, wherein one of the two output shafts is guided axially through the drive shaft. Preferably the two output shafts are thus arranged on a common drive axle.

Furthermore, it is preferred if an additional reduction gearing is arranged between the drive shaft and the gear device, in particular the first planetary gear stage. Alternatively, the reduction gearing can also be arranged between the gear device, in particular the second planetary gear stage, and the differential stage. The additional reduction gearing offers the possibility of simply increasing the transmission ratio range that can be achieved.

### BRIEF DESCRIPTION OF THE DRAWINGS

Further measures improving the drive device are shown below together with the description of preferred embodiments with reference to the figures. The figures each show a simplified schematic representation to illustrate the structure of the drive devices according to the disclosure. In the figures:

FIG. 1 shows a first embodiment of the drive device in an axially parallel construction, and

FIG. 2 shows a second embodiment of the drive device in an axially parallel construction.

### DETAILED DESCRIPTION

The figures are only schematic in nature and serve only for understanding the disclosure. The same elements are provided with the same reference symbols. The features of the individual embodiments can be interchanged.

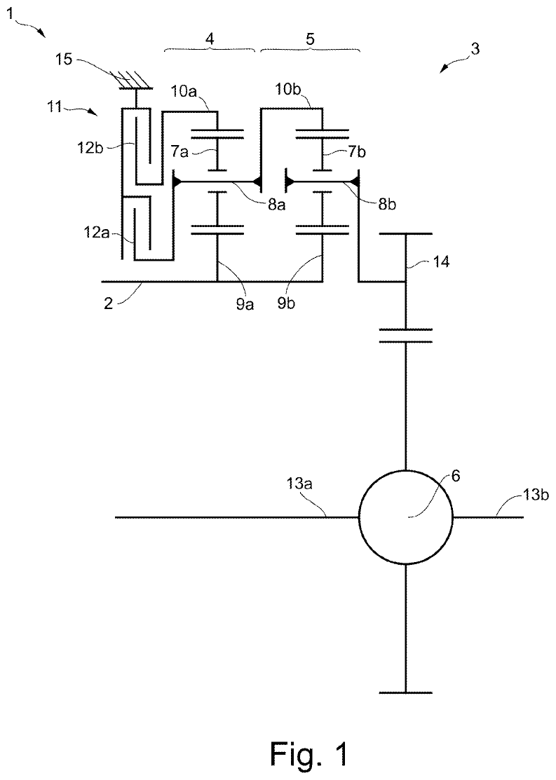

FIG. 1 shows a first embodiment of the drive device 1 in an axially parallel construction.

The drive device 1 according to the first embodiment for a motor vehicle (not shown here) has an electrical drive machine (not shown here) and a transmission device 3. The electrical drive machine has a stator and a rotor. A drive power of the electrical drive machine is transmitted to the transmission device 3 via a drive shaft 2, which is arranged between the electrical drive machine and the transmission device 3 and designed as a rotor shaft.

The transmission device 3 comprises a first and second planetary stage 4, 5 and a differential stage 6. The first planetary stage 4 has a first planet set with a plurality of planet gears 7a, which are rotatably arranged on a first planetary gear carrier 8a and mesh with a first sun gear 9a and a first ring gear 10a. The planet gears 7a of the first planetary gear set therefore mesh radially between the first sun gear 9a and the first ring gear 10a. The drive shaft 2 is connected to the first sun gear 9a in a rotationally fixed manner. The second planetary stage 5 has a second planet set with a plurality of planet gears 7b, which are rotatably arranged on a second planetary gear carrier 8b and mesh with a second sun gear 9b and with a second ring gear 10b. The planet gears 7b of the second planetary gear set therefore mesh radially between the second sun gear 9b and the second ring gear 10b. The drive shaft 2 is also connected to the first sun gear 9a in a rotationally fixed manner.

Furthermore, a dual clutch device 11 with a first clutch 12a and a second clutch 12b is provided. Closing the first clutch 12a and opening the second clutch 12b implements a first gear ratio, wherein closing the second clutch 12b and opening the first clutch 12a implements a second gear ratio. The first gear ratio is not the same as the second gear ratio. Opening both clutches 12a, 12b, implements a power cut-off. In the first embodiment, the dual clutch device 11 is arranged on the input side in the transmission device 3, the first clutch 12a is connected to the first planetary gear carrier 8a in a rotationally fixed (permanent) manner and the second clutch 12b is connected to the first ring gear 10a in a rotationally fixed manner.

On the output side, in the first embodiment, between the second planetary gear stage 5 and the differential stage 6, which distributes the torque to two output shafts 13a, 13b, an additional reduction gearing 14 designed as a spur gear stage is interposed. Alternatively, however, the reduction gearing 14 can also be connected upstream on the input side between the electrical drive machine and the transmission device 3.

The torque of the electrical drive machine causes the drive shaft 2 and the first sun gear 9a and second sun gear 9b, which are formed integrally therewith, to rotate. If the first clutch 12a is now closed (first gear ratio), in the first embodiment the first planetary gear carrier 8a and the second ring gear 10b connected to it in a rotationally fixed manner are fixed in the housing 15 via the dual clutch device 11 fixedly connected to a housing 15. The planet gears 7a of the first planetary gear set 4 therefore roll on the first sun gear 9a, essentially without transmitting torque. In other words, the first planetary gear set 4 runs in “idle” with the first gear ratio and does not transmit any torque. Because of the second ring gear 10b fixed to the frame, the planet gears 7b roll on the second ring gear 10b and thus rotate the second planet gear carrier 8b in the same direction as the sun gear 9b. Via the second planetary gear carrier 8b, the torque emerging from the second planetary gear stage 5 is introduced via the reduction gearing 14 into the differential stage 6 and further distributed to the output shafts 13a and 13b.

The second gear ratio (closing the second clutch 12b) converts the first planetary gear stage 4 into a stationary transmission (dual-shaft transmission) with a stationary gear ratio, wherein the input torque is introduced via the first sun gear 9a and the output torque is introduced via the second ring gear 10b, which is connected to the first planetary gear carrier 8a in a rotationally fixed manner. The planet gears 7a of the first planetary gear set 4 roll on the first ring gear 10a, which is fixed to the housing when the second clutch 12b is engaged, and thus rotate the first planetary gear carrier 8a and the second ring gear 10b, which in turn causes the second planetary gear carrier 8b to start rotating and distributes the introduced torque to the output shafts 13a, 13b via the reduction gearing 14 and the differential stage 6.

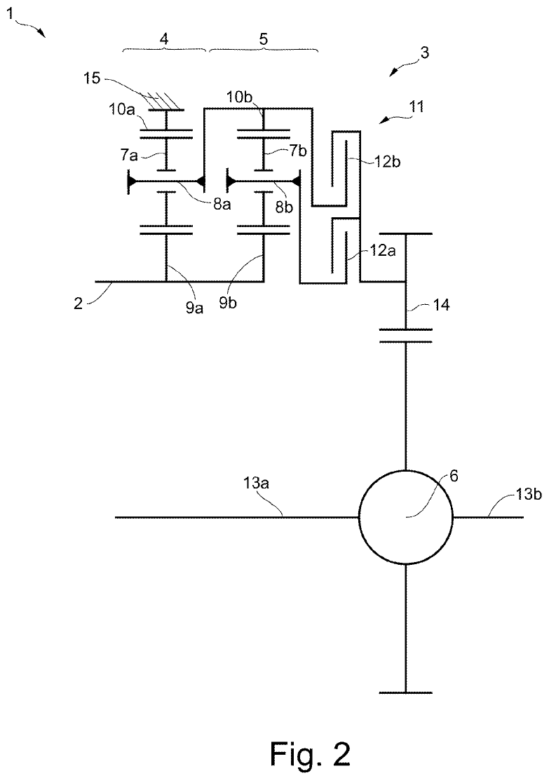

FIG. 2 shows a second embodiment of the drive device 1 in an axially parallel construction. In the following, only the differences from the first embodiment shown in FIG. 1 will be discussed.

In contrast to the first embodiment, in the second embodiment the dual clutch device 11 is arranged on the output side between the second planetary gear set 5 and the reduction gearing 14. The first clutch 12a thus connects the second planetary gear carrier 8b to the reduction gearing 14 in a rotationally fixed manner and the second clutch 12b connects the second ring gear 10b and the first planetary gear carrier 8a, which is connected thereto, in a rotationally fixed manner, to the reduction gearing 14, such that the torque can optionally be transmitted via the second planetary gear carrier 8b (first gear ratio) or the second ring gear 10b (second gear ratio) to the reduction gearing 14 and the differential stage 6 and thus be transmitted to the output shafts 13a, 13b. Furthermore, in the second embodiment, the first ring gear 10a is supported in a fixed manner in the housing 15.

When the first clutch 12a is now closed, the second planetary gear carrier 8b is connected to the reduction gearing 14 in a rotationally fixed manner, as described above. The torque introduced by the electrical drive machine via the drive shaft 2 is transmitted by rolling the planet gears 7a on the first ring gear 10a, fixed to the housing, via the first sun gear 9a to the first planetary gear carrier 8a and the second ring gear 10b and thus drives the second planetary gear carrier 8b.

In the second gear ratio (closing the second clutch 12b), the torque is transmitted to the first planetary gear carrier 8a via the first sun gear 9a via the planet gears 7a meshing with the first ring gear 10a fixed to the housing. Due to the rotationally fixed connection between the first planetary gear carrier 8a and the second ring gear 10b, the torque is transmitted via the closed second clutch 12b to the reduction gearing 14 and the differential stage 6, where it is finally distributed to the output shafts 13a, 13b.

Two embodiments of a drive device 1 have been described above by way of example. However, it goes without saying that the present invention is not limited thereto, but rather is determined by the scope of protection defined in the claims.

Thus, according to the embodiments described above, the drive devices are designed to be axially parallel. However, a drive device according to the disclosure can also be designed coaxially, i.e., the drive machine is arranged coaxially to the differential stage. In particular, the output shafts can be guided coaxially in a drive shaft designed as a hollow shaft.

In the drive devices described above, the reduction gearing is also arranged on the output side between the second planetary gear stage and the differential stage. Alternatively, however, the reduction gearing can also be interposed on the input side between the electrical drive machine and the transmission device, or it can be omitted.

### LIST OF REFERENCE SYMBOLS

1 Drive device
2 Drive shaft
3 Transmission device
4 First planetary gear stage
5 Second planetary gear stage
6 Differential stage
7a First planetary gear(s)
7b Second planetary gear(s)
8a First planetary gear carrier
8b Second planetary gear carrier
9a First sun gear
9b Second sun gear
10a First ring gear
10b Second ring gear
11 Dual clutch device
12a First clutch
12b Second clutch
13a, 13b Output shafts
14 Reduction gearing
15 Housing

1. A drive device for a motor vehicle, comprising:
an electrical drive machine which is operatively connected to a transmission device by a drive shaft;
the transmission device has a first planetary gear stage, a second planetary gear stage, and a differential stage;
the first planetary stage comprises a first planetary gear set having a plurality of planetary gears that are rotatably arranged on a first planetary gear carrier and mesh with a first sun gear and with a first ring gear;
the second planetary gear stage comprises a second planetary gear set having a plurality of planetary gears that are rotatably arranged on a second planetary gear carrier and mesh with a second sun gear and with a second ring gear;
the first and the second planetary gear stages are operatively connected to a dual clutch device which contains a first and a second load-switchable clutch;
the first sun gear and the second sun gear are interconnected in a rotatable manner and the drive shaft is operatively connected to both the first and the second sun gears; and
the first sun gear and the second sun gear have a same half circuit diameter, the first planetary gear carrier is connectable to a housing in a fixed manner via the first clutch, and the first ring gear is connectable to the housing in a fixed manner via the second clutch.

2. The drive device according to claim 1, wherein a toothing of the first sun gear is designed identical to a toothing of the second sun gear.

3. The drive device according to claim 1, wherein the second planetary gear carrier is operatively connected to the differential stage.

4. A drive device for a motor vehicle, comprising:
an electrical drive machine which is operatively connected to a transmission device by a drive shaft;
the transmission device has a first planetary gear stage, a second planetary gear stage, and a differential stage;
the first planetary stage comprises a first planetary gear set having a plurality of planetary gears that are rotatably arranged on a first planetary gear carrier and mesh with a first sun gear and with a first ring gear;
the second planetary gear stage comprises a second planetary gear set having a plurality of planetary gears that are rotatably arranged on a second planetary gear carrier and mesh with a second sun gear and with a second ring gear;
the first and the second planetary gear stages are operatively connected to a dual clutch device which contains a first and a second load-switchable clutch;
the first sun gear and the second sun gear are interconnected in a rotatable manner and the drive shaft is operatively connected to both the first and the second sun gears; and
the first sun gear and the second sun gear have a same half circuit diameter, the second planet carrier is configured to can be operatively connected to the differential stage via the first clutch and the second ring gear is configured to be operatively connected to the differential stage via the second clutch.

5. The drive device according to claim 4, wherein the first ring gear is connected in a fixed manner to the housing.

6. The drive device according to claim 4, wherein a toothing of the first sun gear is designed identical to a toothing of the second sun gear.

7. The drive device according to claim 1, wherein the first planetary gear carrier is connected to the second ring gear in a rotationally fixed manner.

8. The drive device according to claim 1, wherein opening both of the clutches implements a power cut-off.

9. The drive device according to claim 1, wherein closing the first clutch and opening the second clutch implements a first gear ratio, and closing the second clutch and opening the first clutch implements a second gear ratio.

10. The drive device according to claim 1, wherein the drive machine is offset axially parallel or is arranged coaxially to the differential stage.

11. A drive device for a motor vehicle, comprising;
a drive shaft configured to transmit a drive input to a transmission;
the transmission has a first planetary gear stage, a second planetary gear stage, and a differential stage;
the first planetary stage comprises a first planetary gear set having a plurality of planetary gears that are rotatably arranged on a first planetary gear carrier and mesh with a first sun gear and with a first ring gear;
the second planetary gear stage comprises a second planetary gear set having a plurality of planetary gears that are rotatably arranged on a second planetary gear carrier and mesh with a second sun gear and with a second ring gear;
the first and the second planetary gear stages are operatively connected to a dual clutch device which contains a first and a second load-switchable clutch;
the first sun gear and the second sun gear are interconnected in a rotatable manner and the drive shaft is operatively connected to both the first and the second sun gears; and
the first sun gear and the second sun gear have a same half circuit diameter, the first planetary gear carrier is connectable to a housing in a fixed manner via the first clutch, and the first ring gear is connectable to the housing in a fixed manner via the second clutch.

12. The drive device according to claim 11, wherein a toothing of the first sun gear is identical to a toothing of the second sun gear.

13. The drive device according to claim 11, wherein the second planetary gear carrier is operatively connected to the differential stage.

14. The drive device according to claim 11, wherein the first planetary gear carrier is connected to the second ring gear in a rotationally fixed manner.

15. The drive device according to claim 11, wherein opening both of the clutches implements a power cut-off.

16. The drive device according to claim 11, wherein closing the first clutch and opening the second clutch implements a first gear ratio, and closing the second clutch and opening the first clutch implements a second gear ratio.

17. The drive device according to claim 11, wherein the drive machine is offset axially parallel or is arranged coaxially to the differential stage.

18. The drive device according to claim 4, wherein the first planetary gear carrier is connected to the second ring gear in a rotationally fixed manner.

19. The drive device according to claim 4, wherein opening both of the clutches implements a power cut-off.

20. The drive device according to claim 4, wherein closing the first clutch and opening the second clutch implements a first gear ratio, and closing the second clutch and opening the first clutch implements a second gear ratio.
